(19) United States
(12) Patent Application Publication
(10) Pub. No.: US 2014/0179210 A1
(43) Pub. Date: Jun. 26, 2014

(54) WELDING FUME COLLECTOR

(71) Applicant: DEERE AND COMPANY, Moline, IL (US)

(72) Inventor: John M. Holmes, Colona, IL (US)

(73) Assignee: Deere and Company, Moline, IL (US)

(21) Appl. No.: 13/722,012

(22) Filed: Dec. 20, 2012

(51) Int. Cl. B08B 15/02

(52) U.S. Cl. CPC B08B 15/02
USPC 454/56

(57) ABSTRACT

A welding fume collector is disclosed that includes a sheath, fume collection opening and vacuum hose. A welding torch extends through the sheath with the nozzle extending beyond the distal end of the sheath. The fume collection opening is at the distal end of the sheath. The vacuum hose extends into the proximal end of the sheath. A vacuum system creates a negative pressure inside the sheath which extends out through the collection opening to collect fumes. The collection opening can be generally elliptical with a major axis extending along the welding direction. The vacuum system, vacuum hose and sheath can be sized to create the desired vacuum to collect welding fumes without interfering with the welding process. The diameters of the vacuum hose and sheath can be sized to create low-speed welding fume collection through the collection opening. The vacuum system can include a self-cleaning filter.

### FIELD OF THE INVENTION

The present invention generally relates to the field of fume collection, and more specifically to a system and method for collection of fumes from a welding torch as it travels up into the atmosphere before it disburses away from the capture area.

### BACKGROUND OF THE INVENTION

Welding fumes include many metallic particles that can be hazardous to the health of people. In addition, particle fallout from the welding fumes can be deposited around a factory or work area in the form of dust. It would be desirable to avoid one or both of these conditions.

One possible solution is to scrub the air with a large air handling system, however this can only start after the fumes are disbursed around the factory or work area and it can be cost prohibitive. Alternatively, a high volume vacuum at the end of the welding torch can be used to collect the fumes; however this vacuum can also collect the shield gas needed for the welding process and cause weld defects. The vacuum at the nozzle can be turned off at points of the welding process but this allows the welding fumes to go uncollected.

It would be desirable to collect the welding fumes near the welding torch before they are disbursed around the factory or work area without interfering with the welding process in a way that causes weld defects.

### SUMMARY

A welding fume collector is disclosed for a welding process that uses a welding torch having a nozzle. The welding fume collector includes a sheath, a fume collection opening and a vacuum hose coupled to a vacuum system. The sheath has a proximal end and a distal end, where the welding torch extends through the sheath with the nozzle of the welding torch extending beyond the distal end of the sheath. The fume collection opening is at the distal end of the sheath. The vacuum hose extends into the proximal end of the sheath. The vacuum system creates a negative pressure inside the sheath which extends out through the fume collection opening to collect welding fumes. The fume collection opening can have a generally elliptical shape. The generally elliptical shape of the fume collection opening can have a major axis extending along the welding direction and a minor axis perpendicular to the welding direction. The major axis can be about 46 millimeters and the minor axis can be about 36 millimeters. The major axis and the minor axis can both pass through the welding torch where it passes through the fume collection opening.

The vacuum system, vacuum hose and sheath can be sized to create the desired vacuum to collect the welding fumes without interfering with the welding process. The fume collection opening can be positioned far enough above the nozzle of the welding torch to avoid collection of shield gas where recompression of the welding fumes occurs. The fume collection opening can be positioned in the recompression area of the welding fumes. The fume collection opening can be positioned to take advantage of the fluid flow of the welding fumes. The diameter of the vacuum hose and the diameter of the sheath can be sized to create a low-speed collection of welding fumes through the fume collection opening. The diameter of the vacuum hose can be smaller than the diameter of the sheath. The fume collection opening can be significantly larger than the nozzle of the welding torch, for example about 100 times larger than the nozzle of the welding torch. The welding torch can extend through substantially the center of the fume collection opening. The vacuum system can include a self-cleaning filter system for collecting the welding fumes. The welding system can be a robotic welding system.

### BRIEF DESCRIPTION OF THE DRAWINGS

FIG. 1 illustrates a side view of an exemplary embodiment of a welding fume collector coupled to the front end of a welding torch;

FIG. 2 illustrates an under-side view of the exemplary embodiment of a welding fume collector coupled to the front end of a welding torch;

FIG. 3 illustrates a cross-section of the welding fume collector near the proximal end of the sheath;

FIG. 4 illustrates an under-side view of an alternative exemplary embodiment of a sheath for a welding fume collector; and

FIG. 5 illustrates a side view of the alternative exemplary embodiment of a sheath for a welding fume collector.

### DETAILED DESCRIPTION

For the purposes of promoting an understanding of the principles of the novel invention, reference will now be made to the embodiments described herein and illustrated in the drawings and specific language will be used to describe the same. It will nevertheless be understood that no limitation of the scope of the novel invention is thereby intended, such alterations and further modifications in the illustrated devices and methods, and such further applications of the principles of the novel invention as illustrated therein being contemplated as would normally occur to one skilled in the art to which the novel invention relates.

A welding fume collector can be positioned near the welding torch to collect the fumes before being disbursed throughout the work area. The fume collector can be used for robotic welding in a factory and in other situations. The collector can be designed to capture fumes as they travel up into the atmosphere before they disburse away from the capture area.

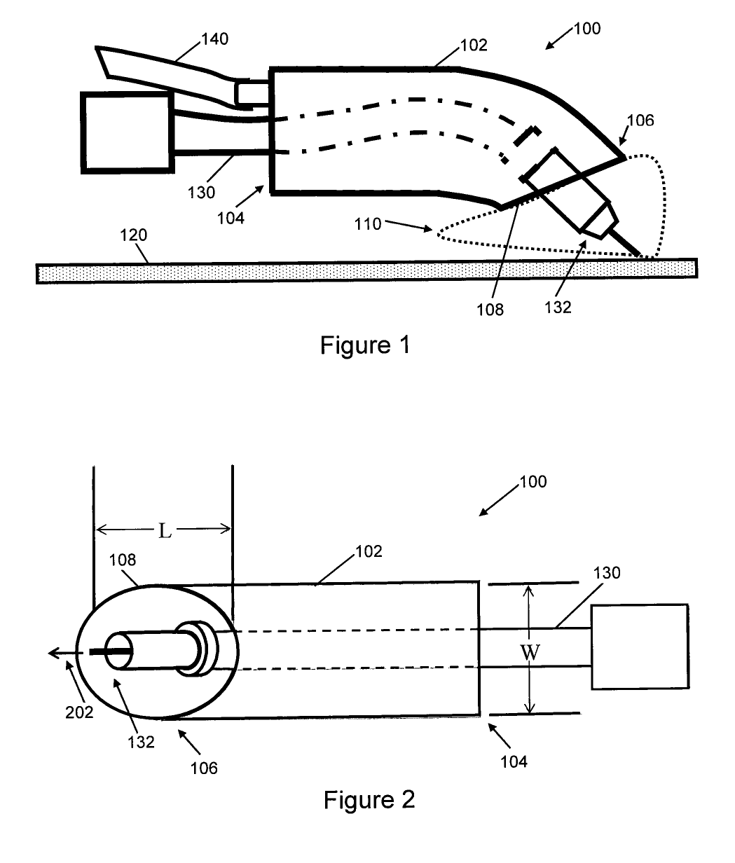

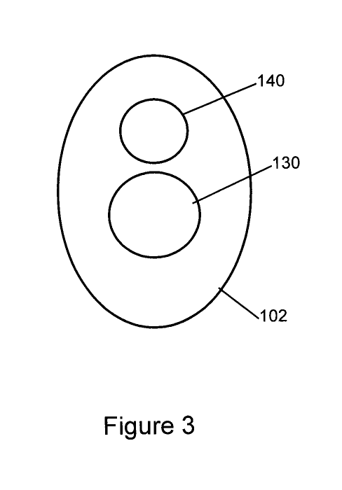

FIGS. 1-3 illustrate views of an exemplary embodiment of a welding fume collector 100 coupled to the front end of a welding torch 130. The welding fume collector 100 includes a sheath 102 having a proximal end 104 and a distal end 106, with a fume collection opening 108 at the distal end 106. The welding fume collector 102 also includes a vacuum hose 140 extending into the proximal end 104 of the sheath 102 to create negative pressure in the interior of the sheath 102 which extends out through the fume collection opening 108. The welding torch 130 extends through the interior of the sheath 102 from the proximal end 104 to the distal end 106 and a nozzle 132 of the welding torch 130 extends through the fume collection opening 108. FIG. 3 shows a cross-section of the welding fume collector 100 near the proximal end 104 of the sheath 102. FIG. 3 shows the vacuum hose 140 and the welding torch 130 in the interior of the sheath 102. The vacuum system and hose 140 and the sheath 102 can be sized to create the desired vacuum to collect the welding fumes without interfering with the welding process. FIG. 1 illustrates welding on a work piece 120 and a fume collection area 110 emanating from the fume collection opening 108 around the nozzle 132 of the welding torch 130 where the welding fume collector 100 through the vacuum hose 140 collects fumes during the welding process.

The welding fume collector 100 should be positioned above the welding arc far enough to avoid collection of the shield gas where the recompression of the fumes occurs. The collector 100 creates a vacuum or low pressure collection area 110 where the welding fumes are collected. The low pressure evenly collects the fumes into the fume collection opening 108. The welding fume collector 100 can be coupled to the welding nozzle 132 to allow the fume collection opening 108 to be in the recompression area. The welding fume collector 100 can be positioned to take advantage of the fluid flow of the fumes.

This welding fume collector 100 can have a generally oval or elliptical collector opening 108 with the longer major axis extending along the welding direction in front and behind the welding arc and the shorter minor axis being perpendicular to the welding direction. The vacuum can be introduced to the sheath 102 through a significantly smaller vacuum hose 140 at a high pressure and volume. When the collector opening 108 is significantly larger than the vacuum hose 140, there will be a significant pressure drop at the collector opening 108 allowing for a low speed collection of the welding fumes. A high volume vacuum at the end of a welding torch can cause welding defects if in the process of capturing the welding fumes it also collects the shield gas needed for the welding process. This can be avoided by using a welding fume collector with a collector opening that is significantly larger than the size of the shield gas nozzle, for example a hundred times the size of the shield gas nozzle 132. This allows the welding process to be successful without introducing weld defects while the collector is collecting welding fumes.

FIG. 2 shows a length dimension L and a width dimension W for the fume collection opening 108. FIG. 2 also shows an arrow 202 indicating the direction of welding using the welding nozzle 132. As shown in FIG. 2, the length L of the fume collection opening 108 is along the welding direction, and the width W of the fume collection opening 108 is perpendicular to the welding direction. The fume collection opening 108 can have a generally elliptical shape with the length L being along the major axis and the width W being along the minor axis of the generally elliptical fume collection opening 108. For example and not limitation, the fume collection opening 108 can have an elliptical opening with a length dimension L in the welding direction of 46 mm, and a width dimension W perpendicular to the welding direction of 36 mm.

The vacuum or low pressure is introduced at the proximal end 104 of the sheath 102 by the vacuum hose 140. Having a larger cross-section for the sheath 102 than for the vacuum hose 140 produces a lower pressure collection of the welding fumes through the collection opening 108 of the sheath 102. The welding nozzle 132 can be substantially in the center of the cross-section for the sheath 102. When the welding process melts the steel or other material 120 through the nozzle 132, welding fumes are generated. The pressure from the shielding gas forces the fumes away from the welding area. The fume collector opening 108 of the collector 100 can be positioned far enough away from the welding area to allow the inertia of the shield gas to be dissipated allowing the collection of the welding fumes to be more effective.

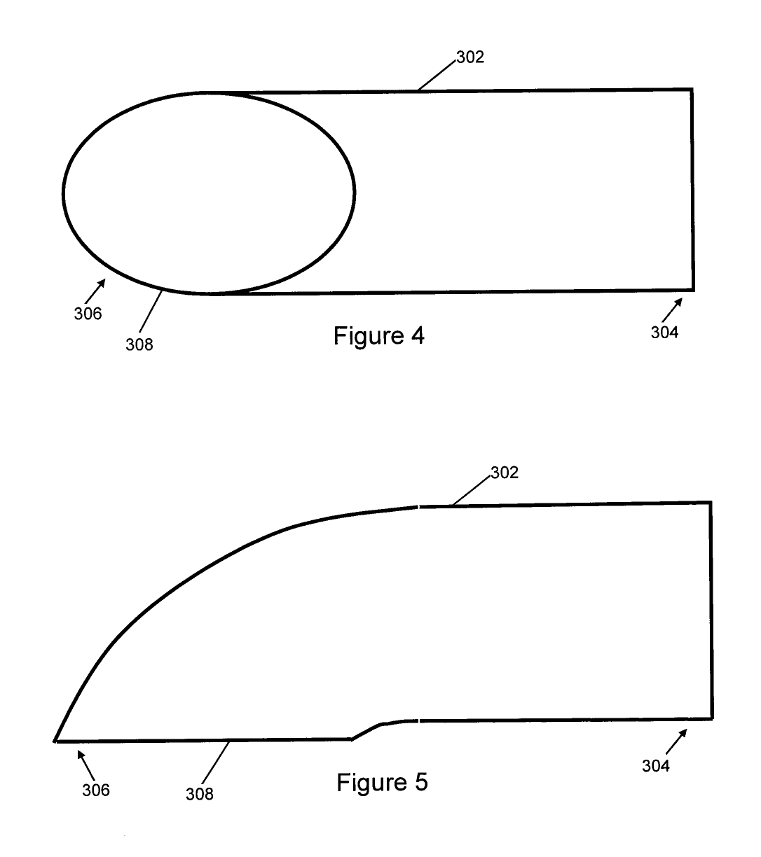

FIGS. 4 and 5 illustrate an alternative exemplary embodiment of a welding fume collector 302 having a proximal end 304 and a distal end 306, with a fume collection opening 308 at the distal end 306 having a generally oval or elliptical shape. This alternative embodiment shows the length of the fume collection opening 308 along the welding direction being larger than the width W of the fume collection opening 108 perpendicular to the welding direction.

The welding fume collector 100 sucks the welding fumes through the fume collection opening 108 up through the vacuum hose 140 where it passes through filters to remove particles and other components of the welding fumes. The vacuum level through the vacuum hose 140 and the fume collection opening 108 drops over the life of these filters as they fill up with debris. A self cleaning filter system can help alleviate this vacuum reduction issue as the welding fume typically includes very small particles.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains.

We claim:

1. A welding fume collector for a welding process using a welding torch having a nozzle, the welding fume collector comprising:
a sheath having a proximal end and a distal end, the welding torch extending through the sheath with the nozzle of the welding torch extending beyond the distal end of the sheath;
a fume collection opening at the distal end of the sheath;
a vacuum hose coupled to a vacuum system, the vacuum hose extending into the proximal end of the sheath; and
wherein the vacuum system creates a negative pressure inside the sheath which extends out through the fume collection opening to collect welding fumes.

2. The welding fume collector of claim 1, wherein the fume collection opening has a generally elliptical shape.

3. The welding fume collector of claim 2, wherein the vacuum system, the vacuum hose and the sheath are sized to create the desired vacuum to collect the welding fumes without interfering with the welding process.

4. The welding fume collector of claim 2, wherein the fume collection opening is positioned in the recompression area of the welding fumes.

5. The welding fume collector of claim 2, wherein the diameter of the vacuum hose and the diameter of the sheath are sized to create a low-speed collection of welding fumes through the fume collection opening.

6. The welding fume collector of claim 2, wherein the welding torch extends through substantially the center of the fume collection opening.

7. The welding fume collector of claim 2, wherein the generally elliptical shape of the fume collection opening has a major axis extending along the welding direction and a minor axis perpendicular to the welding direction.

8. The welding fume collector of claim 3, wherein the major axis is about 46 millimeters and the minor axis is about 36 millimeters.

9. The welding fume collector of claim 3, wherein the major axis and the minor axis both pass through the nozzle of the welding torch.

10. The welding fume collector of claim 1, wherein the vacuum system, the vacuum hose and the sheath are sized to create the desired vacuum to collect the welding fumes without interfering with the welding process.

11. The welding fume collector of claim 1, wherein the fume collection opening is positioned far enough above the nozzle of the welding torch to avoid collection of shield gas where recompression of the welding fumes occurs.

12. The welding fume collector of claim 1, wherein the fume collection opening is positioned in the recompression area of the welding fumes.

13. The welding fume collector of claim 1, wherein the fume collection opening is positioned to take advantage of the fluid flow of the welding fumes.

14. The welding fume collector of claim 1, wherein the diameter of the vacuum hose and the diameter of the sheath are sized to create a low-speed collection of welding fumes through the fume collection opening.

15. The welding fume collector of claim 1, wherein the diameter of the vacuum hose is smaller than the diameter of the sheath.

16. The welding fume collector of claim 1, wherein the fume collection opening is significantly larger than the nozzle of the welding torch.

17. The welding fume collector of claim 16, wherein the fume collection opening is about 100 times larger than the nozzle of the welding torch.

18. The welding fume collector of claim 1, wherein the welding torch extends through substantially the center of the fume collection opening.

19. The welding fume collector of claim 1, wherein the vacuum system includes a self-cleaning filter system for collecting the welding fumes.

20. The welding fume collector of claim 1, wherein the welding system is a robotic welding system.
